(19) United States
(12) Patent Application Publication
(10) Pub. No.: US 2023/0016960 A1
(43) Pub. Date: Jan. 19, 2023

(54) LIVE MEETING ASSISTANCE FOR CONNECTING TO A NEW MEMBER

(71) Applicant: Avaya Management L.P., Durham, NC (US)

(72) Inventors: Harshal Ramesh Gawande, Pune (IN); Ghanshyam Asaram Baheti, Pune (IN); Ajay Jagdish Talreja, Pune (IN)

(21) Appl. No.: 17/376,456

(22) Filed: Jul. 15, 2021

(51) Int. Cl. H04L 29/06; G06F 40/166; G06F 40/247; G10L 15/22; H04L 12/58; G06N 3/08

(52) U.S. Cl. CPC H04L 65/1093; G06F 40/166; G06F 40/247; G10L 15/22; H04L 51/18; H04L 65/403; G06N 3/08; G10L 2015/223

(57) ABSTRACT

Meetings conducted over a network are commonplace. It is also commonplace that the participants of a meeting cannot resolve an issue that could be resolved by a non-attending party. Accordingly, systems and methods are provided wherein an unresolvable issue (for the attendees of a meeting) may be resolved by an absent participant. A message generated comprising a summary of the issue and automatically sent to the absent participant. A reply is then presented to the meeting, which may be an answer or other information or action, or the absent participant may elect to join the meeting and interact with the others in the meeting.

### COPYRIGHT NOTICE

A portion of the disclosure of this patent document contains material that is subject to copyright protection. The copyright owner has not objected to the facsimile reproduction by anyone of the patent document or the patent disclosure as it appears in the Patent and Trademark Office patent files or records, but otherwise reserves all copyright rights whatsoever.

### FIELD OF THE DISCLOSURE

The invention relates generally to systems and methods for detecting an issue requiring an ad hoc communication and particularly to automatically generating a message to resolve the issue or facilitate the addition of a previously absent node into a network topology.

### BACKGROUND

In ongoing electronic meetings, such as those utilizing Avaya Spaces®, multiple participants discuss multiple topics. Often a topic is discussed that requires input from an absent participant who did not join the meeting or was not invited. The absence of the required input may cause the meeting to become, in whole or in part, unproductive.

Prior art systems may attempt to contact an absent participant, such as with a different communication device or application, such as to call or message. However, such systems need to be available, which may not be the case if the systems and components are already allocated for the meeting, or if the identity of the absent participant and/or their contact information are unknown.

### SUMMARY

An electronic meeting comprises two or more participants communicating over a network via their respective communication devices (herein, “meeting”). While additional individuals may participate in the meeting in-person, such as by sharing a device (e.g., phone with speakerphone engaged) with two or more participants, at least two communication devices and at least one individual is associated with each of the two communication devices as provided herein. As used herein, “meeting” excludes all communications between people that rely on human senses (e.g., hearing, speaking), except those that additionally require at least two communication devices to communicate via the network.

A meeting may encounter an issue that requires the input from an individual that is not presently connected to the meeting (“absent participant”). An absent participant is not a participant in the meeting at a first time, such as the time when the issue was encountered. The absent participant may not have been invited to attend the meeting or, if invited, did not accept the invitation, or accepted the invitation but is not presently attending. In the prior art, a meeting attendee may attempt to utilize a different communication mode and/or device to contact the absent participant. For example, the meeting may be conducted utilizing audio and video and, when an issue is encountered, one of the participants utilizes another device and/or a messaging feature in an attempt to reach the absent participant to resolve the issue. During this time, the participant attempting to contact the absent participant is distracted and may be required to pause the conference and/or repeat certain portions thereof—wasting time, network resources, and computing resources by extending the meeting, as well as the resources utilized to attempt to connect to the absent participant. This can present a significant amount of overhead. Even if the issue can be resolved quickly (e.g., ask a question that the absent participant can readily answer, such as a yes/no question), the overhead utilized to connect to the absent participant is disproportionately large in comparison to the brevity of the response. Such solutions also assume that such alternative channels of communication exist and/or are available for use. For example, when utilizing a single-line telephone, a participant may need to disconnect from the conference, place a call to the absent participant, and rejoin the conference. The absent participant may not answer the call or may not be able to answer the question quickly when reached. As a result, the participant attempting contact is thereby absent from the conference and must reconnect in order to relay the information they received from the absent participant—whether or not it addresses the issue.

These and other needs are addressed by the various embodiments and configurations of the present invention. The present invention can provide a number of advantages depending on the particular configuration. These and other advantages will be apparent from the disclosure of the invention(s) contained herein.

Systems and methods are provided to automatically detect when input from an absent participant is required in order to resolve an issue being discussed during the meeting. Once an issue is detected, a message is formatted to present the issue and then sent to the absent participant. Upon receipt of the message, the absent participant may then provide a response or elect to join the meeting, all without any current participant of the meeting having to initiate a new communication channel or having to leave the conferencing application utilized to present the meeting.

In one embodiment, systems and methods automatically format and send a message to the absent participant. The message may be in the form of audio when a voice call is utilized, video, and/or text (e.g., instant messaging (IM), simple messaging system (SMS), email, chat, etc.). The message comprises context of the specific issue that needs resolved. For example, the message may identify the meeting (e.g., “the installation team”, “weekly service-ticket review,” etc.) and/or the particular issue to be resolved (e.g., “Will feature X be included in the next release?”, “Did the new customer decide the initial install would be at site 1 or site 2?”, etc.). As a benefit, the absent participant presented with the initial message can be made aware of the circumstances that triggered the message. The absent participant may be presented with an option to join the meeting by selecting a graphical element, such as a button, presented on the absent participant's device. As a further option, the absent participant may be presented with a number of communication formats to choose from, such as audio-only, audio-video, and/or text. If the absent participant fails to respond or responds without agreeing to join the meeting or provide a resolution to the issue, the meeting may continue. Even though resolution of the issue was not obtained, the participants of the meeting can proceed, such as onto other topics, without delay in knowing that a resolution will not be obtained at the current time.

For voice-only messages, an automated spoken message is generated and presented live or, if unanswered, to a voicemail system. If presented live, a prompt may be included in the message to solicit a response and receive an input comprising the answer for presentation to the current participants of the meeting and/or receive an input to a prompt that allows the absent participant to join the meeting. For example, “The installation team meeting is currently underway. They want to know if the install will be next Tuesday or if it was rescheduled. Please provide your answer now or, alternatively, say ‘join’ to be connected to the meeting.” If presented to a voicemail system, the options may include a request to contact one or more of the participants and/or to join the meeting later. For example, “During the installation team meeting a question arose about whether the installation was still happening on Tuesday or if it was rescheduled. Please contact Alice when you are able. The meeting is scheduled to last until 9:30, if you are able to join, please call 555.555.5555, with meeting code 11223344.” Text messages may be formatted similarly. As a further embodiment, the message may be specific to a conferencing application which presents the message and configures the conferencing application to connect to the conference.

Exemplary aspects are directed to:

A system, comprising: a network interface to a network; a data storage accessible to the processor; and a processor comprising at least one microprocessor having instructions maintained in a non-transitory memory that cause the processor to automatically perform: monitoring meeting content of a meeting between a plurality of communication devices communicating via the network for an unresolvable issue that requires input from an absent participant that is not currently participating in the meeting; upon determining an unresolvable issue is present, identifying the absent participant comprising identifying a record, from a number of records maintained in the data storage, that associates the unresolvable issue with the absent participant; generating a message comprising at least one of indicia of the unresolvable issue, indicia of the meeting, or indicia of at least one participant in the meeting; sending the message to an absent participant device associated with the absent participant; and in response to receiving a reply message from the absent participant device, inserting indicia of the reply message into the meeting.

A method of operating a processor comprising at least one microprocessors, comprising: monitoring, by the processor via a network interface to a network, meeting content of a meeting between a plurality of communication devices communicating via the network for an unresolvable issue that requires input from an absent participant that is not currently participating in the meeting; upon determining an unresolvable issue is present, identifying the absent participant comprising identifying a record, from a number of records maintained in a data storage, that associates the unresolvable issue with the absent participant; generating a message comprising at least one of indicia of the unresolvable issue, indicia of the meeting, or indicia of at least one participant in the meeting; sending the message to an absent participant device associated with the absent participant; and in response to receiving a reply message from the absent participant device, inserting indicia of the reply message into the meeting.

A system, comprising: means to monitor a network interface to a network, meeting content of a meeting between a plurality of communication devices communicating via the network for an unresolvable issue that requires input from an absent participant that is not currently participating in the meeting; means to determine an unresolvable issue is present, identifying the absent participant comprising identifying a record, from a number of records maintained in a data storage, that associates the unresolvable issue with the absent participant; means to generate a message comprising at least one of indicia of the unresolvable issue, indicia of the meeting, or indicia of at least one participant in the meeting; means to send the message to an absent participant device associated with the absent participant; and means to, in response to receiving a reply message from the absent participant device, insert indicia of the reply message into the meeting.

Any of the above aspects:

wherein the processor inserts indicia of the reply message into the meeting further comprising joining the absent participant device to the meeting when the reply message comprises an offer to connect the meeting and the reply message comprises acceptance of the offer.

wherein the processor generates the message comprising a link that, when selected via an input to the absent participant device, causes the absent participant device to join to the conference via an address within the link.

wherein determining the unresolvable issue is present further comprises presenting the meeting content to a neural network trained to detect the unresolvable issues.

further comprising: wherein the instructions further cause the processor to perform training the neural network, comprising: collecting a set of issues discussed in a number of prior meetings from the data storage; applying one or more transformations to each issue of the set of issues including one or more of substituting a word with a synonymous word, substituting a word with a synonymous phrase, substituting a purpose for an issue associated with the purpose, substituting the issue associated with the purpose for the purpose, inserting at least one redundant word, removing at least one redundant word, removing a first unique issue, and adding a second unique issue to create a modified set of issues discussed; creating a first training set comprising the collected set of subjects discussed, the modified set of issues discussed, and a set of resolvable issues; training the neural network in a first stage using the first training set; creating a second training set for a second stage of training comprising the first training set and the set of resolvable issues that are incorrectly detected as one of the set of unresolvable issues after the first stage of training; and training the neural network in the second stage using the second training set.

wherein the processor generates the message comprising an audio message.

wherein the processor inserts indicia of the reply message into the meeting further comprising joining the absent participant device to the meeting when the reply message comprises an offer to connect the meeting and the reply message comprises acceptance of the offer.

wherein the processor generates the message comprising a voice prompt that, when selected via at least one of a spoken command or selected via input to a key of a keypad, causes the absent participant device to join to the conference.

wherein the processor identifies the absent participant further comprising identifying the record, from a subset of the number of records maintained in the data storage, that associates the unresolvable issue with the absent participant, wherein the subset comprises at least one of records associated with a whitelist of included absent participants or records not associated with a blacklist of excluded absent participants.

wherein the processor identifies the absent participant further comprising identifying the record, from a subset of the number of records maintained in the data storage, that associates the unresolvable issue with the absent participant, wherein the subset comprises records associated with non-accepting absent participants that were invited to attend the meeting but are not presently joined to the meeting.

wherein the processor identifies the absent participant further comprising identifying the record, from a subset of the number of records maintained in the data storage, that associates the unresolvable issue with the absent participant, wherein the subset comprises records associated with a set of absent participants that have attended a prior meeting of which the meeting is a subsequent iteration thereof.

wherein inserting indicia of the reply message into the meeting further comprising joining the absent participant device to the meeting when the reply message comprises an offer to connect the meeting and the reply message comprises acceptance of the offer.

wherein generating the message comprising a link that, when selected via an input to the absent participant device, causes the absent participant device to be joined to the conference via an address within the link.

wherein determining the unresolvable issue is present further comprises presenting the meeting content to a neural network trained to detect the unresolvable issues.

further comprising: collecting a set of issues discussed in a number of prior meetings from the data storage; applying one or more transformations to each issue of the set of issues including one or more of substituting a word with a synonymous word, substituting a word with a synonymous phrase, substituting a purpose for an issue associated with the purpose, substituting the issue associated with the purpose for the purpose, inserting at least one redundant word, removing at least one redundant word, removing a first unique issue, and adding a second unique issue to create a modified set of issues discussed; creating a first training set comprising the collected set of subjects discussed, the modified set of issues discussed, and a set of resolvable issues; training the neural network in a first stage using the first training set; creating a second training set for a second stage of training comprising the first training set and the set of resolvable issues that are incorrectly detected as one of the set of unresolvable issues after the first stage of training; and training the neural network in the second stage using the second training set.

wherein generating the message comprises generating an audio message.

wherein inserting indicia of the reply message into the meeting further comprising joining the absent participant device to the meeting when the reply message comprises an offer to connect the meeting and the reply message comprises acceptance of the offer.

wherein generating the message comprising a voice prompt that, when selected via at least one of a spoken command or input to a key of a keypad, causes the absent participant device to join to the conference.

A system on a chip (SoC) including any one or more of the above aspects or embodiments described herein.

One or more means for performing any one or more of the above aspects or embodiments described herein.

Any aspect in combination with any one or more other aspects.

Any one or more of the features disclosed herein.

Any one or more of the features as substantially disclosed herein.

Any one or more of the features as substantially disclosed herein in combination with any one or more other features as substantially disclosed herein.

Any one of the aspects/features/embodiments in combination with any one or more other aspects/features/embodiments.

Use of any one or more of the aspects or features as disclosed herein.

Any of the above aspects, wherein the data storage comprises a non-transitory storage device comprise at least one of: an on-chip memory within the processor, a register of the processor, an on-board memory co-located on a processing board with the processor, a memory accessible to the processor via a bus, a magnetic media, an optical media, a solid-state media, an input-output buffer, a memory of an input-output component in communication with the processor, a network communication buffer, and a networked component in communication with the processor via a network interface.

It is to be appreciated that any feature described herein can be claimed in combination with any other feature(s) as described herein, regardless of whether the features come from the same described embodiment.

The phrases “at least one,” “one or more,” “or,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B, and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible, non-transitory medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below. Also, while the disclosure is presented in terms of exemplary embodiments, it should be appreciated that an individual aspect of the disclosure can be separately claimed.

### BRIEF DESCRIPTION OF THE DRAWINGS

The present disclosure is described in conjunction with the appended figures:

FIG. 1 depicts a first system in accordance with embodiments of the present disclosure;

FIG. 2 depicts a message delivery in accordance with embodiments of the present disclosure;

FIG. 3 depicts an interaction in accordance with embodiments of the present disclosure;

FIG. 4 depicts a first process in accordance with embodiments of the present disclosure;

FIG. 5 depicts a second process in accordance with embodiments of the present disclosure;

FIG. 6 depicts a third process in accordance with embodiments of the present disclosure;

FIG. 7 depicts a device in a second system in accordance with embodiments of the present disclosure; and

FIG. 8 depicts a data structure in accordance with embodiments of the present disclosure.

### DETAILED DESCRIPTION

The ensuing description provides embodiments only and is not intended to limit the scope, applicability, or configuration of the claims. Rather, the ensuing description will provide those skilled in the art with an enabling description for implementing the embodiments. It will be understood that various changes may be made in the function and arrangement of elements without departing from the spirit and scope of the appended claims.

Any reference in the description comprising a numeric reference number, without an alphabetic sub-reference identifier when a sub-reference identifier exists in the figures, when used in the plural, is a reference to any two or more elements with a like reference number. When such a reference is made in the singular form, but without identification of the sub-reference identifier, is a reference to one of the like numbered elements, but without limitation as to the particular one of the elements. Any explicit usage herein to the contrary or providing further qualification or identification shall take precedence.

The exemplary systems and methods of this disclosure will also be described in relation to analysis software, modules, and associated analysis hardware. However, to avoid unnecessarily obscuring the present disclosure, the following description omits well-known structures, components, and devices, which may be omitted from or shown in a simplified form in the figures or otherwise summarized.

For purposes of explanation, numerous details are set forth in order to provide a thorough understanding of the present disclosure. It should be appreciated, however, that the present disclosure may be practiced in a variety of ways beyond the specific details set forth herein.

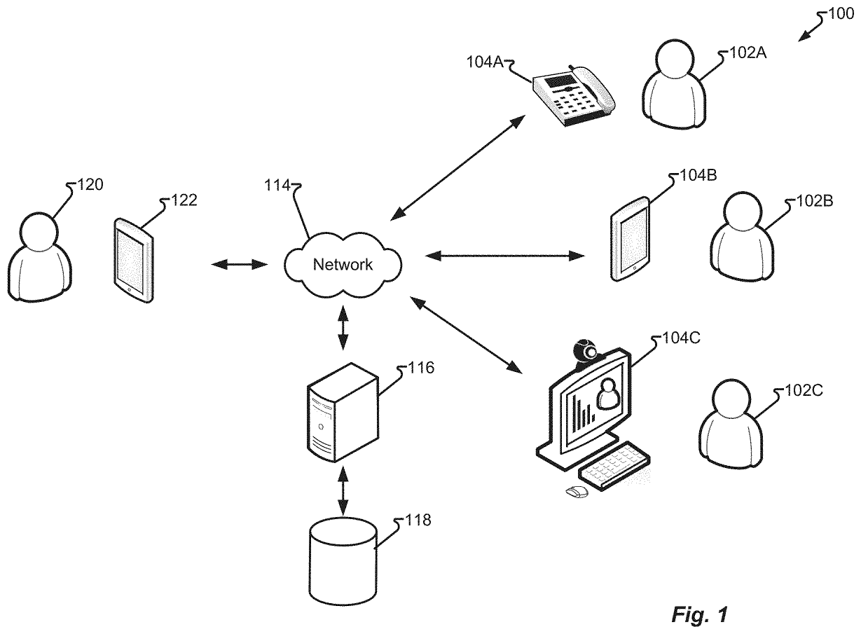

FIG. 1 depicts system 100 in accordance with embodiments of the present disclosure. In one embodiment, a meeting is being conducted between a number of participant communication devices 104, such as participant communication device 104A-C, utilized by participant 102, such as participant 102A-C, respectively. Server 116 may provide hosting services (e.g., floor control, media coding/decoding, add/drop participants, etc. and utilize data storage 118 for the storage of data. It should be appreciated that system 100 illustrates one topology but that others may be deployed without departing from the scope of the embodiments herein. For example, server 116 may be a local server to one of the participant communication devices 104 or be integrated therewith. Participant communication devices 104 may comprise any form of communication device operable to communicate via network 114. Devices, for example participant communication device 104A may be embodied as a voice-only telephone may be limited to communicating via encoded audio whereas participant communication device 104B, in one embodiment is a smart phone, and/or participant communication device 104C, in one embodiment is a computer having text, audio, and video capabilities may be capable of using additional/alternative forms of communication (e.g., audio, video, text messages, email, screen sharing, document sharing, co-browsing, etc.).

During the meeting, server 116 utilizes a processor, which may comprise or utilize one or more microprocessors (e.g., cores, blades, server farm, server array, computing cloud, etc.). Server 116 monitors the content of the meeting (e.g., spoken content on an audio channel, visual content on a video channel, text messages, etc.) to determine if an unresolvable issue is present. As used herein, an “unresolvable issue” is any issue that cannot be resolved solely by participants 102 who are currently engaged in the meeting. Another party may be identified as being able to resolve the unresolvable issue, such as absent participant 120. While this may or may not prove accurate, absent participant 120 is at least a party determined to be potentially able to resolve the unresolvable issue. Examples of unresolvable issues include obtaining information not available to any of participants 102 or an action that cannot be performed by any of participants 102, such as an action, decision, fact, etc. that is currently unknown, unauthorized, or inaccessible to participants 102.

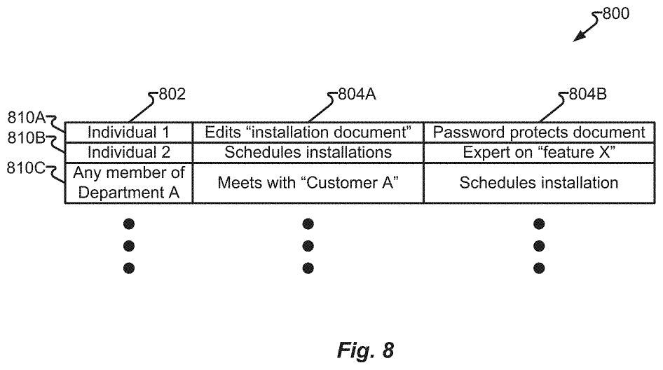

The determination that an unresolvable issue is present in the meeting content is described more completely with respect to embodiments that follow. Once an unresolvable issue is identified, data storage 118 determines if a match (e.g., an exact match or a match within an acceptable variation threshold) is found in a data record, such as one maintained in data storage 118. For example, a record maybe a portion of a database or other data structure comprising a listing of individuals, such as absent participant 120, and attributes associated therewith (see, data structure 800, FIG. 8). The attributes comprising one or more abilities or areas of knowledge and, if a match is determined, the server automatically generates a message and sends a message to an address of a device, such as absent participant device 122, for absent participant 120.

Once an absent participant 120 is selected, from a number of absent participants 120, server 116 generates a message, which is variously embodied. For example, the message may be formatted based on a media type associated with absent participant device 122. If absent participant device 122 is an audio device (e.g., speech), the message is formatted as a voice message comprising generated speech. Additionally or alternatively, the message may comprise video. Similarly, the message may be formatted as text or a communication application-specific message. Server 116 may utilize a whitelist and/or blacklist, such as maintained in data storage 118. For example, only a subset of all employees of a company may be identified to receive the message, such as members of a team, department, or set of specific individuals. Conversely, certain individuals may be excluded from being considered absent participant 120, for example, even if the president of the company likely has this information to resolve an unresolvable issue, send the message to the next best-match. As a further embodiment, each participant 102 should be excluded from consideration as the absent participant 120.

The message may comprise indicia of the sending party (e.g., one or more participants 102) and/or indicia of the meeting (e.g., “installation document review meeting”). Additionally or alternatively, the message may comprise indicia of the unresolved issue. For example, “The sales team meeting is currently discussing last quarter's sales and need the spreadsheet with the latest figures. Can you provide this information?” As another example, “The installation team is discussing the roll-out for Client X and would like to know if it will be installed in site 1 or site 2. Do you know?” In one embodiment, the message may be sent automatically, with no human input. In another embodiment, the message may be formatted and sent, pending approval, and/or sent automatically if not canceled.

The message may comprise a number of options for receiving a reply from absent participant device 122. A prompt may be presented, visual (e.g., graphical element), textually, or audibly, asking for absent participant 120 to select one of a number of responses. For example, to answer with a specific response (e.g., “The customer wants to use site 2 for the first installation.”), select a preselected option (e.g., “Yes”, “No.”), or optionally, select to join the meeting. If absent participant 120 wishes to join the meeting, then selecting the option connects absent participant device 122 to the conference. It should be appreciated that there may be a number of iterations for the messages sent, and replies received from absent participant device 122. For example, an initial question soliciting a response of a specific date may not be forthcoming and may further require a follow-up discussions or clarifying questions (e.g., “Client X has not signed the purchase order, so no installation is scheduled. Are you thinking of Client Y?”). On a second, or other subsequent iteration of message-response, if not included in a prior message, the invitation to join the conference may be added to a subsequent message.

As a benefit of the foregoing, participants 102, do not need to leave the meeting or otherwise establish a separate communication channel with absent participant 120 in order to either receive resolution to the unresolvable issue; everything remains within the meeting application/interface, which may be managed by server 116, such as to record, transcribe, or otherwise manage and/or preserve the meeting. The resolution then coming in the form of a direct response from absent participant 120 and absent participant device 122 and/or by having absent participant device 122 joined to the meeting. If the unresolvable issue cannot be resolved by absent participant 120 (e.g., “I don't have that information. Ask Alice.”) then, a next individual(s) is/are selected either from data storage 118 and the message resent to a subsequent absent participant 120, and/or the reply is incorporated such as knowing the appropriate person (e.g., “Alice has that information”).

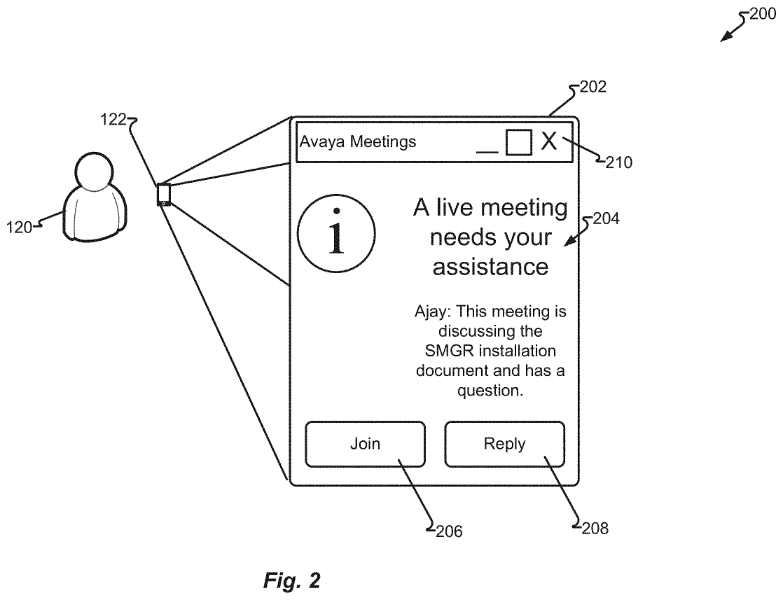

FIG. 2 depicts message delivery 200 in accordance with embodiments of the present disclosure. Upon identification of an unresolvable issue and an associated party (e.g., absent participant 120) that may resolve the unresolvable issue, server 116 sends a message to absent participant device 122. For example, application dialog 202 may be the output of an application, such as a conferencing or other communication application, executing on absent participant device 122. The content comprises identification of who and/or what the issue to be resolved is and provides option for absent participant 120 to resolve the issue, such as by selecting button 206 to be connected to the meeting or button 208 to provide a reply. If absent participant 120 is unable to respond, window control options 210 may be utilized to dismiss the notification. Dismissing the notification may provide a reply, such as to indicate that the message will not be substantively answered and/or someone else should be contacted.

In another embodiment, absent participant device 122 is an audio-only device, or otherwise determined that the message sent by server 116 should be audio only. Accordingly, encoded audio is sent and received by absent participant device 122. The message may then speak, with generated speech, the reason for the message and/or the information requested. A prompt may be provided in terms of a voice response (e.g., “say ‘join’ to join the meeting in process) or other input, such as an input to a key to generate a dual-tone multi frequency signal (DTMF) (e.g., “to answer ‘yes’, press 1; to answer ‘no’, press 2; to join the call, press 3”). If the message is delivered to a voicemail system, the message may comprise a callback number. In other embodiments, such as those utilizing text, a link (e.g., network address, session initiation protocol (SIP) address, uniform resource locator (URL), etc.) may be included to allow absent participant 120 to send a response or to join the meeting.

The content of message 204 may be generated via an artificial intelligent agent (AI), such as a neural network. As will be discussed more completely with respect to embodiments that follow, the neural network may be provided with the content of the meeting and determine an unresolvable issue is present and format the content of message 204 to illicit a response to resolve the unresolvable issue, via receiving an answer from absent participant 120 and/or have absent participant 120 join the meeting.

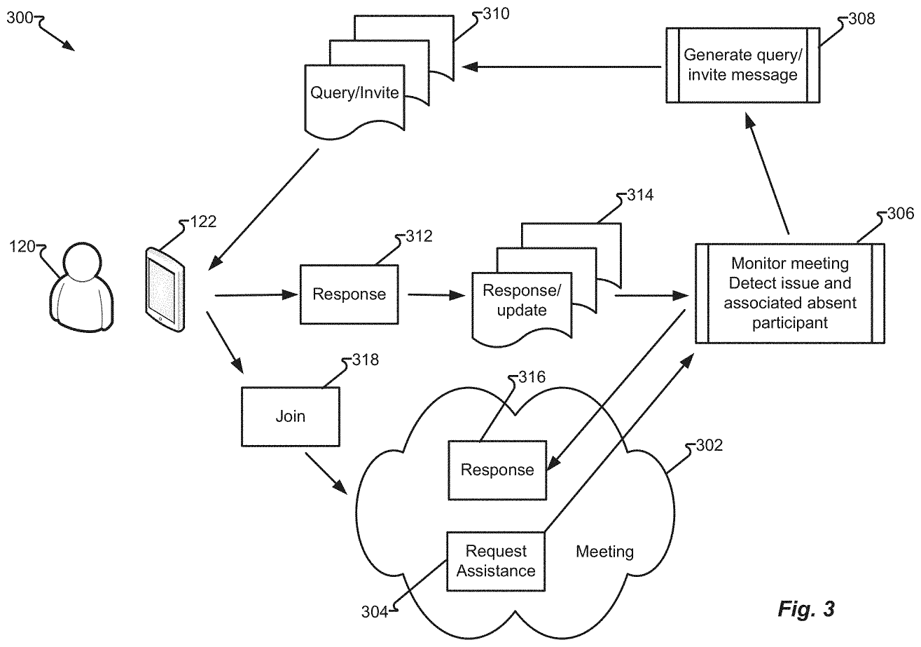

FIG. 3 depicts interaction 300 in accordance with embodiments of the present disclosure. Meeting 302 is underway, such as comprising a plurality of participant communication device 104 utilized by a respective plurality of participant 102 communicating via network 114 and server 116 performs operation 306 is performed to monitor the meeting. The content of the meeting is analyzed to determine if assistance is required and, if so, server 116 performs operation 304 to requests assistance from absent participant 120. Operation 304 may be performed automatically, semi-automatically (e.g., performed unless canceled), and/or manually via input to one of participant communication devices 104.

Server 116 performs operation 308 to generate the message, which may further include previously determined responses for selection, such as an answer or an invitation to join the meeting. Message(s) 310 are then sent for delivery to absent participant device 122. In response, absent participant device 122, in response to an input from absent participant 120, provides response 312, which is then processed (e.g., formatted) into response(s) 314 and provided to operation 306. In turn, the response or indicia of the response (e.g., “Alice declined to respond.”) is provided to the meeting in operation 316. The response may be in the same or different media. For example absent participant 120 may utilize absent participant device 122 to create a video message to respond to an audio or text message as response 312. Alternatively, absent participant device 122 may respond by joining and, accordingly, join operation 318 adds absent participant device 122 to meeting 302.

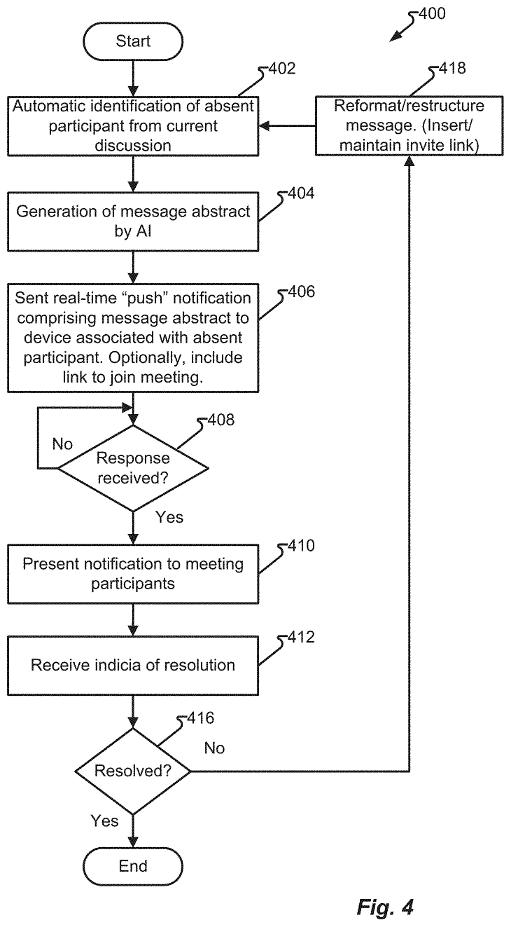

FIG. 4 depicts process 400 in accordance with embodiments of the present disclosure. In one embodiment, process 400 is further embodied as machine-readable instructions maintained in a non-transitory storage that, when read by a processor, such as a processor server 116, cause the processor to perform the steps of process 400. Process 400 illustrates one process wherein a processor automatically generates and/or selects a recipient device for a message and manages the reply therefrom.

Process 400 begins and monitors the content (e.g., speech, text, etc.) of a meeting wherein an unresolvable issue has been determined. Step 402 then automatically selects a particular absent participant 120 from a number of potential absent participants, such as via accessing a data record maintained in data storage 118. In order to improve selection efficiency, step 402 may first determine if any invitees to the meeting are not in attendance. If so, a lesser threshold of certainty may be utilized to select one of the non-attending invitees as absent participant 120. For example, Alice was invited to attend the meeting but either declined or did not join the meeting, whereas Bob was never invited. If an unresolvable issue arises, a match in a record for Bob having matching attributes may need to be determined to match the unresolvable issue at a higher threshold (e.g., 70%) to be selected over Alice having a record with matching attributes determined to match the unresolved issue at a lower threshold (e.g., 50%) but was invited to attend the meeting.

It should be appreciated that the processor, in analyzing the meeting contents, may extract a specific individual as being absent participant 120. For example, the meeting content may identify the unresolvable issue and add an identifier, such as, “Alice is the only one who knows” or “If Alice would have joined, she would tell us,” would cause the message to be address to Alice.

Next a message is generated comprising content determined, in whole or in part, by an AI agent, such as a neural network. Step 406 then “pushes” a notification to a device (e.g., absent participant device 122) associated with the selected absent participant 120. Step 406 may derive an abstract or other summary of the unresolvable issue. For example, if participants 102 are discussing whether an upcoming installation will or will not conflict with a trade show, various comments may be extracted from the meeting content (e.g., “Is it still on the 17^{th}? If it's the 17^{th}, I can't do it.” “It might be, but I'm gone that whole week.” “I know they were considering a different week.”) which may be aggregated and condensed into an abstract (e.g., “The meeting participants need to know the date for the installation.”). The message is then sent.

Test 408 determines if a reply is received. If test 408 is determined in the negative, test 408 may loop until such time as a reply is received or until the meeting ends. Once test 408 is determined in the affirmative, processing continues to step 410 wherein a notification may be presented (e.g., “Automated Host: I have asked Alice about the date and will update you when a reply is received.”).

Step 412 may continue monitoring the meeting to determine if the reply resolved the unresolvable issue. For example, a resolving reply may provide a specific answer (e.g., “Yes, it is on the 17^{th}.”) or absent participant 120 may elect to join the meeting. Accordingly, test 416 is determined in the affirmative. However, if no resolution is received (e.g., the reply message is “recipient unavailable”, “I don't know,” “which installation are you asking about?” or “Ask Alice.”) then processing may continue to step 418, such as to identify a different absent participant 120, add new content (e.g., “The installation for ‘Client X”), and/or include a link that, when selected on absent participant device 122 causes absent participant device 122 to join the meeting. Accordingly, process 400 may repeat steps 404-416 until test 416 is determined in the affirmative and terminates.

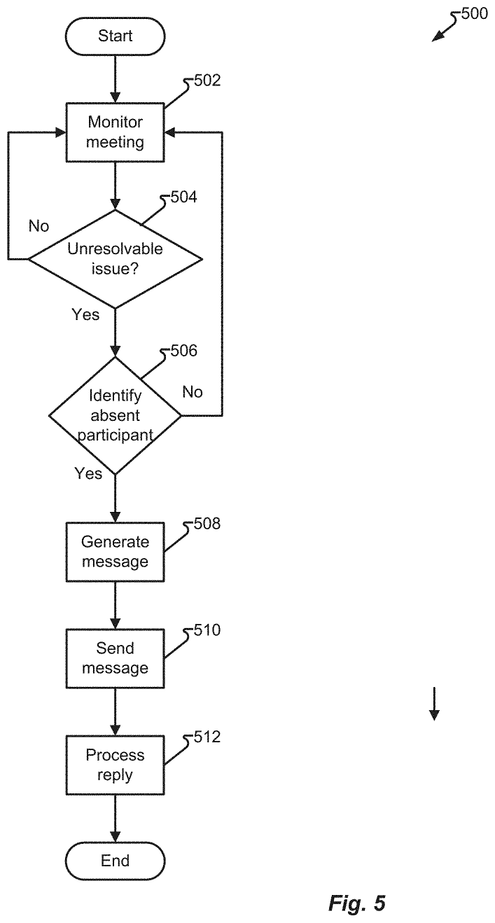

FIG. 5 depicts process 500 in accordance with embodiments of the present disclosure. In one embodiment, process 500 is further embodied as machine-readable instructions maintained in a non-transitory storage that, when read by a processor, such as a processor server 116, cause the processor to perform the steps of process 500. Process 500 illustrates one process wherein an unresolvable issue may be determined to be present and a resolution sought from an absent participant.

Process 500 begins and step 502 monitors the content of a meeting. Although step 502 is illustrated as a discrete step, step 502 may execute continually during the meeting. If test 504 determines whether unresolvable issue is present. If test 504 is determined in the negative, processing loops back to step 502 until the meeting concludes. If test 504 is determined in the affirmative, processing continues to test 506 to determine whether a particular absent participant 120 is identified. For example, the meeting content may include an inability or absence of knowledge to address an issue, such as, “We need the new numbers from Bob,” “I can see if Alice has that,” etc. If test 506 is determined in the negative, processing continues back to step 502. If test 506 is determined in the affirmative, processing continues to test 508 wherein a message is generated, such as comprising indicia of the unresolved issue, meeting, and/or the meeting attendees (participants 102) and utilizing a form of communication, such as may be selected in accordance with a specific absent participant device 122 (e.g., voice for a voice-only telephone, audio-video for computer or smartphone) and/or other preferences. Step 510 sends the message. Step 512 then processes the reply, which may comprise presenting the reply or indicia of the reply to the participants and/or joining absent participant 120 to the meeting.

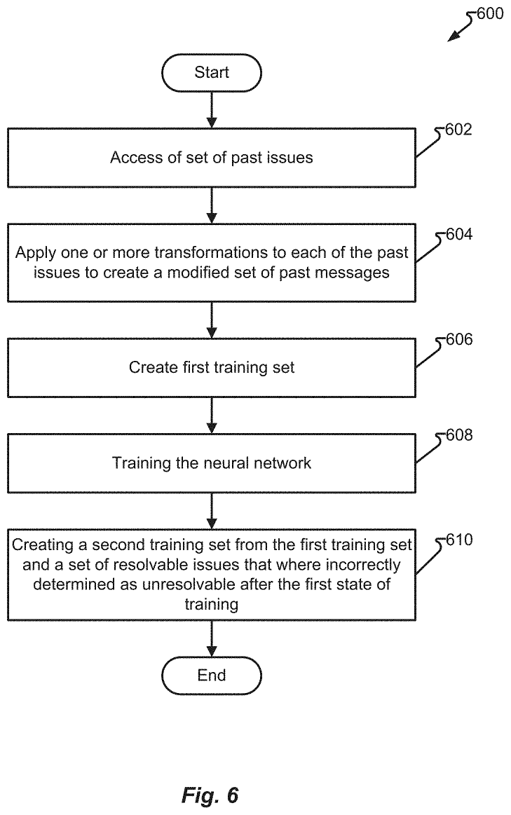

FIG. 6 depicts process 600 in accordance with embodiments of the present disclosure. In one embodiment, process 600 is further embodied as machine-readable instructions maintained in a non-transitory storage that, when read by a processor, such as a processor server 116, cause the processor to perform the steps of process 600. Process 600 illustrates one process wherein a neural network is trained and, upon being trained, able to receive meeting content and determine if an unresolvable issue is present.

A neural network, as is known in the art and in one embodiment, self-configures layers of logical nodes having an input and an output. If an output is below a self-determined threshold level, the output is omitted (i.e., the inputs are within the inactive response portion of a scale and provide no output), if the self-determined threshold level is above the threshold, an output is provided (i.e., the inputs are within the active response portion of a scale and provide an output), the particular placement of the active and inactive delineation is provided as a training step or steps. Multiple inputs into a node produce a multi-dimensional plane (e.g., hyperplane) to delineate a combination of inputs that are active or inactive.

Process 600 begins and step 602 accesses a set of past issues, such as from prior meetings and/or other communications. Step 604 provides one or more transformations to the issues such as substituting a word with a synonymous word, substituting a word with a synonymous phrase, substituting a purpose for an issue associated with the purpose, substituting the issue associated with the purpose for the purpose, inserting at least one redundant word, removing at least one redundant word, removing a first unique issue, and adding a second unique issue to create a modified set of modified past issues.

Step 606 then creates a first training set from the set of past issues and modified set of past issues and, in step 608, trains the neural network in step 608. Step 610 then creates a second training set from the first training set and a set of resolvable issues that where incorrectly determined to be unresolvable after the first training set. As described above, an unresolvable issue is unresolvable if the attendees of a particular meeting (e.g., participants 102) are unable to resolve the issue and/or a non-attendee (e.g., absent participant 120) is able to resolve the issue, such as by performing an action, providing information, or by joining the meeting.

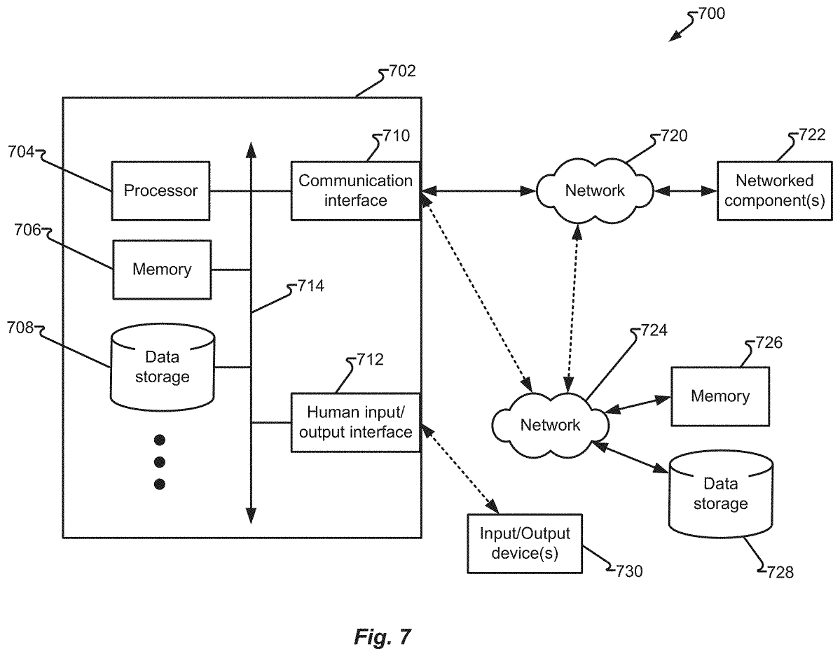

FIG. 7 depicts device 702 in system 700 in accordance with embodiments of the present disclosure. In one embodiment, server 116 may be embodied, in whole or in part, as device 702 comprising various components and connections to other components and/or systems. The components are variously embodied and may comprise processor 704. The term “processor,” as used herein, refers exclusively to electronic hardware components comprising electrical circuitry with connections (e.g., pin-outs) to convey encoded electrical signals to and from the electrical circuitry. Processor 704 may be further embodied as a single electronic microprocessor or multiprocessor device (e.g., multicore) having electrical circuitry therein which may further comprise a control unit(s), input/output unit(s), arithmetic logic unit(s), register(s), primary memory, and/or other components that access information (e.g., data, instructions, etc.), such as received via bus 714, executes instructions, and outputs data, again such as via bus 714. In other embodiments, processor 704 may comprise a shared processing device that may be utilized by other processes and/or process owners, such as in a processing array within a system (e.g., blade, multi-processor board, etc.) or distributed processing system (e.g., “cloud”, farm, etc.). It should be appreciated that processor 704 is a non-transitory computing device (e.g., electronic machine comprising circuitry and connections to communicate with other components and devices). Processor 704 may operate a virtual processor, such as to process machine instructions not native to the processor (e.g., translate the VAX operating system and VAX machine instruction code set into Intel® 9xx chipset code to allow VAX-specific applications to execute on a virtual VAX processor), however, as those of ordinary skill understand, such virtual processors are applications executed by hardware, more specifically, the underlying electrical circuitry and other hardware of the processor (e.g., processor 704). Processor 704 may be executed by virtual processors, such as when applications (i.e., Pod) are orchestrated by Kubernetes. Virtual processors allow an application to be presented with what appears to be a static and/or dedicated processor executing the instructions of the application, while underlying non-virtual processor(s) are executing the instructions and may be dynamic and/or split among a number of processors.

In addition to the components of processor 704, device 702 may utilize memory 706 and/or data storage 708 for the storage of accessible data, such as instructions, values, etc. Communication interface 710 facilitates communication with components, such as processor 704 via bus 714 with components not accessible via bus 714. Communication interface 710 may be embodied as a network port, card, cable, or other configured hardware device. Additionally or alternatively, human input/output interface 712 connects to one or more interface components to receive and/or present information (e.g., instructions, data, values, etc.) to and/or from a human and/or electronic device. Examples of input/output devices 730 that may be connected to input/output interface include, but are not limited to, keyboard, mouse, trackball, printers, displays, sensor, switch, relay, speaker, microphone, still and/or video camera, etc. In another embodiment, communication interface 710 may comprise, or be comprised by, human input/output interface 712. Communication interface 710 may be configured to communicate directly with a networked component or utilize one or more networks, such as network 720 and/or network 724.

Network 114 may be embodied, in whole or in part, as network 720. Network 720 may be a wired network (e.g., Ethernet), wireless (e.g., WiFi, Bluetooth, cellular, etc.) network, or combination thereof and enable device 702 to communicate with networked component(s) 722. In other embodiments, network 720 may be embodied, in whole or in part, as a telephony network (e.g., public switched telephone network (PSTN), private branch exchange (PBX), cellular telephony network, etc.)

Additionally or alternatively, one or more other networks may be utilized. For example, network 724 may represent a second network, which may facilitate communication with components utilized by device 702. For example, network 724 may be an internal network to a business entity or other organization, whereby components are trusted (or at least more so) that networked components 722, which may be connected to network 720 comprising a public network (e.g., Internet) that may not be as trusted.

Components attached to network 724 may include memory 726, data storage 728, input/output device(s) 730, and/or other components that may be accessible to processor 704. For example, memory 726 and/or data storage 728 may supplement or supplant memory 706 and/or data storage 708 entirely or for a particular task or purpose. For example, memory 726 and/or data storage 728 may be an external data repository (e.g., server farm, array, “cloud,” etc.) and allow device 702, and/or other devices, to access data thereon. Similarly, input/output device(s) 730 may be accessed by processor 704 via human input/output interface 712 and/or via communication interface 710 either directly, via network 724, via network 720 alone (not shown), or via networks 724 and 720. Each of memory 706, data storage 708, memory 726, data storage 728 comprise a non-transitory data storage comprising a data storage device.

It should be appreciated that computer readable data may be sent, received, stored, processed, and presented by a variety of components. It should also be appreciated that components illustrated may control other components, whether illustrated herein or otherwise. For example, one input/output device 730 may be a router, switch, port, or other communication component such that a particular output of processor 704 enables (or disables) input/output device 730, which may be associated with network 720 and/or network 724, to allow (or disallow) communications between two or more nodes on network 720 and/or network 724. For example, a connection between one particular customer, using a particular participant communication device 104 and/or absent participant device 122, may be enabled (or disabled) with a particular networked component 722. One of ordinary skill in the art will appreciate that other communication equipment may be utilized, in addition or as an alternative, to those described herein without departing from the scope of the embodiments.

FIG. 8 depicts data structure 800 in accordance with embodiments of the present disclosure. In one embodiment, data structure 800 comprises a number of entries 810 for each of a number of entities (e.g., individuals, departments, teams, etc.). Field 802 maintains the identity of the record wherein field(s) 804 having attributes associated with the corresponding party identified in field 802. It should be appreciated that more or fewer fields 802 may be provided from those illustrated.

Data structure 800 may be populated by various means. In one embodiment, fields 804 may include a particular department (e.g., “sales,” “installation”, etc.). More specific entries may be automatically extracted and provided. For example, during a prior meeting, an individual may be asked for a piece of information (e.g., “Alice, please provide the sales figures from last month.” or, when Alice is providing the meeting content, “Here are the sales figures.”). Accordingly, server 116 and/or other processor may add a field 804 to associate “Alice” with “sales figures.” Should an unresolvable issue arise from a subsequent meeting regarding sales figures, server 116 may identify Alice as the particular absent participant 120 to address the issue.

A neural network, such as the one described with respect to FIG. 5, may be utilized to populate data structure 800. For example, who addresses a particular issue and modifications to the issue may be provided in a first training stage. A second training set may include those issues that were incorrectly associated with a particular individual and provided in a second training stage. For example, “Bob has the new sales figures.” followed by “[Bob speaking] Sorry, that is not me” or “Alice would have that information.”

In the foregoing description, for the purposes of illustration, methods were described in a particular order. It should be appreciated that in alternate embodiments, the methods may be performed in a different order than that described without departing from the scope of the embodiments. It should also be appreciated that the methods described above may be performed as algorithms executed by hardware components (e.g., circuitry) purpose-built to carry out one or more algorithms or portions thereof described herein. In another embodiment, the hardware component may comprise a general-purpose microprocessor (e.g., CPU, GPU) that is first converted to a special-purpose microprocessor. The special-purpose microprocessor then having had loaded therein encoded signals causing the, now special-purpose, microprocessor to maintain machine-readable instructions to enable the microprocessor to read and execute the machine-readable set of instructions derived from the algorithms and/or other instructions described herein. The machine-readable instructions utilized to execute the algorithm(s), or portions thereof, are not unlimited but utilize a finite set of instructions known to the microprocessor. The machine-readable instructions may be encoded in the microprocessor as signals or values in signal-producing components and included, in one or more embodiments, voltages in memory circuits, configuration of switching circuits, and/or by selective use of particular logic gate circuits. Additionally or alternative, the machine-readable instructions may be accessible to the microprocessor and encoded in a media or device as magnetic fields, voltage values, charge values, reflective/non-reflective portions, and/or physical indicia.

In another embodiment, the microprocessor further comprises one or more of a single microprocessor, a multi-core processor, a plurality of microprocessors, a distributed processing system (e.g., array(s), blade(s), server farm(s), “cloud”, multi-purpose processor array(s), cluster(s), etc.) and/or may be co-located with a microprocessor performing other processing operations. Any one or more microprocessor may be integrated into a single processing appliance (e.g., computer, server, blade, etc.) or located entirely or in part in a discrete component connected via a communications link (e.g., bus, network, backplane, etc. or a plurality thereof).

Examples of general-purpose microprocessors may comprise, a central processing unit (CPU) with data values encoded in an instruction register (or other circuitry maintaining instructions) or data values comprising memory locations, which in turn comprise values utilized as instructions. The memory locations may further comprise a memory location that is external to the CPU. Such CPU-external components may be embodied as one or more of a field-programmable gate array (FPGA), read-only memory (ROM), programmable read-only memory (PROM), erasable programmable read-only memory (EPROM), random access memory (RAM), bus-accessible storage, network-accessible storage, etc.

These machine-executable instructions may be stored on one or more machine-readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

In another embodiment, a microprocessor may be a system or collection of processing hardware components, such as a microprocessor on a client device and a microprocessor on a server, a collection of devices with their respective microprocessor, or a shared or remote processing service (e.g., “cloud” based microprocessor). A system of microprocessors may comprise task-specific allocation of processing tasks and/or shared or distributed processing tasks. In yet another embodiment, a microprocessor may execute software to provide the services to emulate a different microprocessor or microprocessors. As a result, first microprocessor, comprised of a first set of hardware components, may virtually provide the services of a second microprocessor whereby the hardware associated with the first microprocessor may operate using an instruction set associated with the second microprocessor.

While machine-executable instructions may be stored and executed locally to a particular machine (e.g., personal computer, mobile computing device, laptop, etc.), it should be appreciated that the storage of data and/or instructions and/or the execution of at least a portion of the instructions may be provided via connectivity to a remote data storage and/or processing device or collection of devices, commonly known as “the cloud,” but may include a public, private, dedicated, shared and/or other service bureau, computing service, and/or “server farm.”

Examples of the microprocessors as described herein may include, but are not limited to, at least one of Qualcomm® Snapdragon® 800 and 801, Qualcomm® Snapdragon® 610 and 615 with 4G LTE Integration and 64-bit computing, Apple® A7 microprocessor with 64-bit architecture, Apple® M7 motion comicroprocessors, Samsung® Exynos® series, the Intel® Core™ family of microprocessors, the Intel® Xeon® family of microprocessors, the Intel® Atom™ family of microprocessors, the Intel Itanium® family of microprocessors, Intel® Core® i5-4670K and i7-4770K 22 nm Haswell, Intel® Core® i5-3570K 22 nm Ivy Bridge, the AMD® FX™ family of microprocessors, AMD® FX-4300, FX-6300, and FX-8350 32 nm Vishera, AMD® Kaveri microprocessors, Texas Instruments® Jacinto C6000™ automotive infotainment microprocessors, Texas Instruments® OMAP™ automotive-grade mobile microprocessors, ARM® Cortex™-M microprocessors, ARM® Cortex-A and ARM926EJ-S™ microprocessors, other industry-equivalent microprocessors, and may perform computational functions using any known or future-developed standard, instruction set, libraries, and/or architecture.

Any of the steps, functions, and operations discussed herein can be performed continuously and automatically.

The exemplary systems and methods of this invention have been described in relation to communications systems and components and methods for monitoring, enhancing, and embellishing communications and messages. However, to avoid unnecessarily obscuring the present invention, the preceding description omits a number of known structures and devices. This omission is not to be construed as a limitation of the scope of the claimed invention. Specific details are set forth to provide an understanding of the present invention. It should, however, be appreciated that the present invention may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components or portions thereof (e.g., microprocessors, memory/storage, interfaces, etc.) of the system can be combined into one or more devices, such as a server, servers, computer, computing device, terminal, “cloud” or other distributed processing, or collocated on a particular node of a distributed network, such as an analog and/or digital telecommunications network, a packet-switched network, or a circuit-switched network. In another embodiment, the components may be physical or logically distributed across a plurality of components (e.g., a microprocessor may comprise a first microprocessor on one component and a second microprocessor on another component, each performing a portion of a shared task and/or an allocated task). It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the invention.

A number of variations and modifications of the invention can be used. It would be possible to provide for some features of the invention without providing others.

In yet another embodiment, the systems and methods of this invention can be implemented in conjunction with a special purpose computer, a programmed microprocessor or microcontroller and peripheral integrated circuit element(s), an ASIC or other integrated circuit, a digital signal microprocessor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this invention. Exemplary hardware that can be used for the present invention includes computers, handheld devices, telephones (e.g., cellular, Internet enabled, digital, analog, hybrids, and others), and other hardware known in the art. Some of these devices include microprocessors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein as provided by one or more processing components.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this invention can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Embodiments herein comprising software are executed, or stored for subsequent execution, by one or more microprocessors and are executed as executable code. The executable code being selected to execute instructions that comprise the particular embodiment. The instructions executed being a constrained set of instructions selected from the discrete set of native instructions understood by the microprocessor and, prior to execution, committed to microprocessor-accessible memory. In another embodiment, human-readable “source code” software, prior to execution by the one or more microprocessors, is first converted to system software to comprise a platform (e.g., computer, microprocessor, database, etc.) specific set of instructions selected from the platform's native instruction set.

Although the present invention describes components and functions implemented in the embodiments with reference to particular standards and protocols, the invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

1. A system, comprising:
a network interface to a network; and
a data storage accessible to a processor; and
wherein the processor comprises at least one microprocessor having instructions maintained in a non-transitory memory that cause the processor to automatically perform:
monitoring meeting content of a meeting between a plurality of communication devices communicating via the network for an unresolvable issue that requires input from an absent participant that is not currently participating in the meeting;
upon determining that the unresolvable issue is present, identifying the absent participant comprising identifying a record, from a number of records maintained in the data storage, that associates the unresolvable issue with the absent participant;
generating a message comprising at least one of indicia of the unresolvable issue, indicia of the meeting, or indicia of at least one participant in the meeting;
sending the message to an absent participant device associated with the absent participant; and
in response to receiving a reply message from the absent participant device, inserting indicia of the reply message into the meeting.

2. The system of claim 1, wherein the processor inserts indicia of the reply message into the meeting further comprising joining the absent participant device to the meeting when the reply message comprises an offer to connect the meeting and the reply message comprises acceptance of the offer.

3. The system of claim 2, wherein the processor generates the message comprising a link that, when selected via an input to the absent participant device, causes the absent participant device to join to the meeting via an address within the link.

4. The system of claim 1, wherein determining that the unresolvable issue is present further comprises presenting the meeting content to a neural network trained to detect unresolvable issues.

5. The system of claim 4, further comprising:
wherein the instructions further cause the processor to perform training the neural network, comprising:
collecting a set of issues discussed in a number of prior meetings from the data storage;
applying one or more transformations to each issue of the set of issues including one or more of substituting a word with a synonymous word, substituting a word with a synonymous phrase, substituting a purpose for an issue associated with the purpose, substituting the issue associated with the purpose for the purpose, inserting at least one redundant word, removing at least one redundant word, removing a first unique issue, and adding a second unique issue to create a modified set of issues discussed;
creating a first training set comprising the collected set of subjects discussed, the modified set of issues discussed, and a set of resolvable issues;
training the neural network in a first stage using the first training set;
creating a second training set for a second stage of training comprising the first training set and the set of resolvable issues that are incorrectly detected as one of a set of unresolvable issues after the first stage of training; and
training the neural network in the second stage using the second training set.

6. The system of claim 1, wherein the processor generates the message comprising an audio message.

7. The system of claim 6, wherein the processor inserts indicia of the reply message into the meeting further comprising joining the absent participant device to the meeting when the reply message comprises an offer to connect the meeting and the reply message comprises acceptance of the offer.

8. The system of claim 6, wherein the processor generates the message comprising a voice prompt that, when selected via at least one of a spoken command or selected via input to a key of a keypad, causes the absent participant device to join to the meeting.

9. The system of claim 1, wherein the processor identifies the absent participant further comprising identifying the record, from a subset of the number of records maintained in the data storage, that associates the unresolvable issue with the absent participant, wherein the subset comprises at least one of records associated with a whitelist of included absent participants or records not associated with a blacklist of excluded absent participants.

10. The system of claim 1, wherein the processor identifies the absent participant further comprising identifying the record, from a subset of the number of records maintained in the data storage, that associates the unresolvable issue with the absent participant, wherein the subset comprises records associated with non-accepting absent participants that were invited to attend the meeting but are not presently joined to the meeting.

11. The system of claim 1, wherein the processor identifies the absent participant further comprising identifying the record, from a subset of the number of records maintained in the data storage, that associates the unresolvable issue with the absent participant, wherein the subset comprises records associated with a set of absent participants that have attended a prior meeting of which the meeting is a subsequent iteration thereof.

12. A method of operating a processor comprising at least one microprocessors, comprising:
monitoring, by the processor via a network interface to a network, meeting content of a meeting between a plurality of communication devices communicating via the network for an unresolvable issue that requires input from an absent participant that is not currently participating in the meeting;
upon determining that the unresolvable issue is present, identifying the absent participant comprising identifying a record, from a number of records maintained in a data storage, that associates the unresolvable issue with the absent participant;
generating a message comprising at least one of indicia of the unresolvable issue, indicia of the meeting, or indicia of at least one participant in the meeting;
sending the message to an absent participant device associated with the absent participant; and
in response to receiving a reply message from the absent participant device, inserting indicia of the reply message into the meeting.

13. The method of claim 12, wherein inserting indicia of the reply message into the meeting further comprising joining the absent participant device to the meeting when the reply message comprises an offer to connect the meeting and the reply message comprises acceptance of the offer.

14. The method of claim 12, wherein generating the message comprising a link that, when selected via an input to the absent participant device, causes the absent participant device to be joined to the meeting via an address within the link.

15. The method of claim 12, wherein determining that the unresolvable issue is present further comprises presenting the meeting content to a neural network trained to detect the unresolvable issues.

16. The method of claim 15, further comprising:
collecting a set of issues discussed in a number of prior meetings from the data storage;
applying one or more transformations to each issue of the set of issues including one or more of substituting a word with a synonymous word, substituting a word with a synonymous phrase, substituting a purpose for an issue associated with the purpose, substituting the issue associated with the purpose for the purpose, inserting at least one redundant word, removing at least one redundant word, removing a first unique issue, and adding a second unique issue to create a modified set of issues discussed;
creating a first training set comprising the collected set of subjects discussed, the modified set of issues discussed, and a set of resolvable issues;
training the neural network in a first stage using the first training set;
creating a second training set for a second stage of training comprising the first training set and the set of resolvable issues that are incorrectly detected as one of a set of unresolvable issues after the first stage of training; and
training the neural network in the second stage using the second training set.

17. The method of claim 12, wherein generating the message comprises generating an audio message.

18. The method of claim 17, wherein inserting indicia of the reply message into the meeting further comprising joining the absent participant device to the meeting when the reply message comprises an offer to connect the meeting and the reply message comprises acceptance of the offer.

19. The method of claim 17, wherein generating the message comprising a voice prompt that, when selected via at least one of a spoken command or input to a key of a keypad, causes the absent participant device to join to the meeting.

20. A system, comprising:
means to monitor a network interface to a network, meeting content of a meeting between a plurality of communication devices communicating via the network for an unresolvable issue that requires input from an absent participant that is not currently participating in the meeting;
means to determine that the unresolvable issue is present, identifying the absent participant comprising identifying a record, from a number of records maintained in a data storage, that associates the unresolvable issue with the absent participant;
means to generate a message comprising at least one of indicia of the unresolvable issue, indicia of the meeting, or indicia of at least one participant in the meeting;
means to send the message to an absent participant device associated with the absent participant; and
means to, in response to receiving a reply message from the absent participant device, insert indicia of the reply message into the meeting.
